(19) United States
(12) Patent Application Publication
(10) Pub. No.: US 2024/0023090 A1
(43) Pub. Date: Jan. 18, 2024

(54) CONFIGURING UPLINK TRANSMISSION CONFIGURATION INDICATOR LIST

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/037,545

(22) PCT Filed: Jan. 11, 2021
(86) PCT No.: PCT/CN2021/071033

§ 371 Date: May 17, 2023

(51) Int. Cl. H04W 72/1268; H04W 72/232; H04W 76/20; H04L 5/00

(52) U.S. Cl. CPC H04W 72/1268; H04W 72/232; H04W 76/20; H04L 5/0051

(57) ABSTRACT

Aspects of the present disclosure include methods and devices for wireless communication including an apparatus, e.g., a UE. The UE may be configured to receive an RRC configuration configuring UL TCI states for one or more serving cells. The UL TCI states may be configured through IEs for configuring PUSCH, PUCCH, SRS, PDSCH, and/or dedicated uplink BWP transmissions. The UE may further be configured to receive DCI indicating an UL TCI state of the configured UL TCI states for at least one UL transmission to at least one serving cell of the one or more serving cells. The UE may also be configured to transmit the at least one UL transmission based on the indicated UL TCI state. The UL transmission based on the indicated UL TCI state may include at least one of a PUSCH transmission, a configured grant PUSCH transmission, a PUCCH transmission, and an SRS transmission.

### BACKGROUND

### Technical Field

The present disclosure relates generally to communication systems, and more particularly, to configuring an uplink (UL) transmission configuration indicator (TCI) list at a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of wireless communications, e.g., 5G NR, downlink (DL) and UL can utilize separate TCI states. For example, a first set of reference signals associated with M TCI states may provide quasi-colocation (QCL) information for at least UE-dedicated reception on physical downlink shared channel (PDSCH) and UE-dedicated reception on all, or a subset, of control resource sets (CORESETs) in a component carrier (CC). The QCL information may identify common characteristics between antenna ports. For example, QCL information may indicate similar doppler shift; doppler spread; average delay; and delay spread (type A), similar doppler shift and doppler spread (type B), similar average delay and delay spread (type C), or a similar spatial receiver parameter used to support beamforming (type D). A second set of reference signals associated with N TCI states may provide a reference for determining a common UL transmission filter (or filters) for at least dynamic-grant/configured-grant based physical uplink shared channel (PUSCH) and all, or a subset, of dedicated physical uplink control channel (PUCCH) resources in a CC. In some configurations, the common UL transmission filter(s) may also apply to sounding reference signal (SRS) resources in one or more resource set(s) configured for any of antenna switching, codebook-based, or non-codebook-based UL transmissions.

In some configurations using carrier aggregation (CA) in which multiple CCs are used by the UE to communicate with a set of one or more serving cells, DL TCI states (e.g., a DL TCI state list) for each particular CC (or for each serving cell) may be configured in a PDSCH configuration (PDSCH-Config) information element (IE) (as an example of a DL config IE) and reused for identifying a TCI state for physical downlink control channel (PDCCH) and/or channel state information reference signals (CSI-RS) for the particular CC. However, for CA UL transmissions on different CCs and/or with different serving cells there may be different UL transmission configurations for the different CCs or serving cells. For example, a particular CC (or serving cell) may have UL transmissions of only one of PUCCH, PUSCH, or SRS transmissions or any combination of PUCCH, PUSCH, configured-grant PUSCH, and SRS transmissions. Because of the different UL transmission configurations for different CCs and/or different serving cells and the different types of UL transmissions that may be exchanged over different CCs associated with different serving cells there may be a benefit to introduce a set of one or more UL TCI state configuration locations (e.g., in one or more information elements in radio resource control (RRC)), where each of the set of one or more locations can be used to configure UL TCI states (e.g., an UL TCI state list) for at least one type of UL transmission (e.g., PUCCH, PUSCH, configured-grant PUSCH, and SRS transmissions).

In an aspect of the disclosure, a method, a computer-readable medium, and an apparatus are provided. The apparatus may be a device at a UE. The device may be a processor and/or modem at a UE or the UE itself. The UE may be configured to receive an RRC configuration configuring UL TCI states for one or more serving cells. The UE may further be configured to receive downlink control information (DCI) indicating an UL TCI state of the configured UL TCI states for at least one UL transmission to at least one serving cell of the one or more serving cells. The UE may also be configured to transmit the at least one UL transmission based on the indicated UL TCI state. The UL transmission based on the indicated UL TCI state may include at least one of a PUSCH transmission, a configured grant PUSCH transmission, a PUCCH transmission, and an SRS transmission.

The RRC configuration may configure the UL TCI states for the one or more serving cells through any of (1) a PUSCH configuration, (2) a PUCCH configuration, (3) an SRS configuration, (4) a dedicated bandwidth part (BWP) configuration, or (5) a PDSCH configuration. The PUSCH configuration, PUCCH configuration, SRS configuration, BWP configuration, or PDSCH configuration may be included in a PUSCH configuration (PUSCH-Config) IE, PUCCH configuration (PUCCH-Config) IE, SRS configuration (SRS-Config) IE, dedicated uplink BWP (BWP-UplinkDedicated) IE, or PDSCH-Config IE, respectively. The PUSCH configuration that configures the UL TCI states, in some embodiments, may exclude other PUSCH-related configuration information (e.g., may be a dummy PUSCH configuration transmitted for the purpose of configuring the UL TCI states without configuring other aspects of the PUSCH).

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call flow diagram illustrating UL TCI state configuration and indication.

FIG. 5 is a call flow diagram illustrating UL TCI state configuration through a PUSCH-Config IE in the set of RRC IEs.

FIG. 6 is a call flow diagram illustrating UL TCI state configuration through a “dummy” PUSCH-Config IE in the set of RRC IEs.

FIG. 7 is a call flow diagram illustrating UL TCI state configuration through a PUCCH-Config IE in the set of RRC IEs.

FIG. 8 is a call flow diagram illustrating UL TCI state configuration through an SRS-Config IE 800 in the set of RRC IEs.

FIG. 9 is a call flow diagram illustrating UL TCI state configuration through a BWP-UplinkDedicatedIE in the set of RRC IEs.

FIG. 10 is a call flow diagram illustrating UL TCI state configuration through a PDSCH-Config IE in the set of RRC IEs.

FIG. 11 is a call flow diagram illustrating UL TCI state configuration through a PUSCH configured grant configuration (ConfiguredGrantConfig) IE in the set of RRC IEs.

FIG. 12 is a flowchart of a method of wireless communication.

FIG. 13 is a diagram illustrating an example of a hardware implementation for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

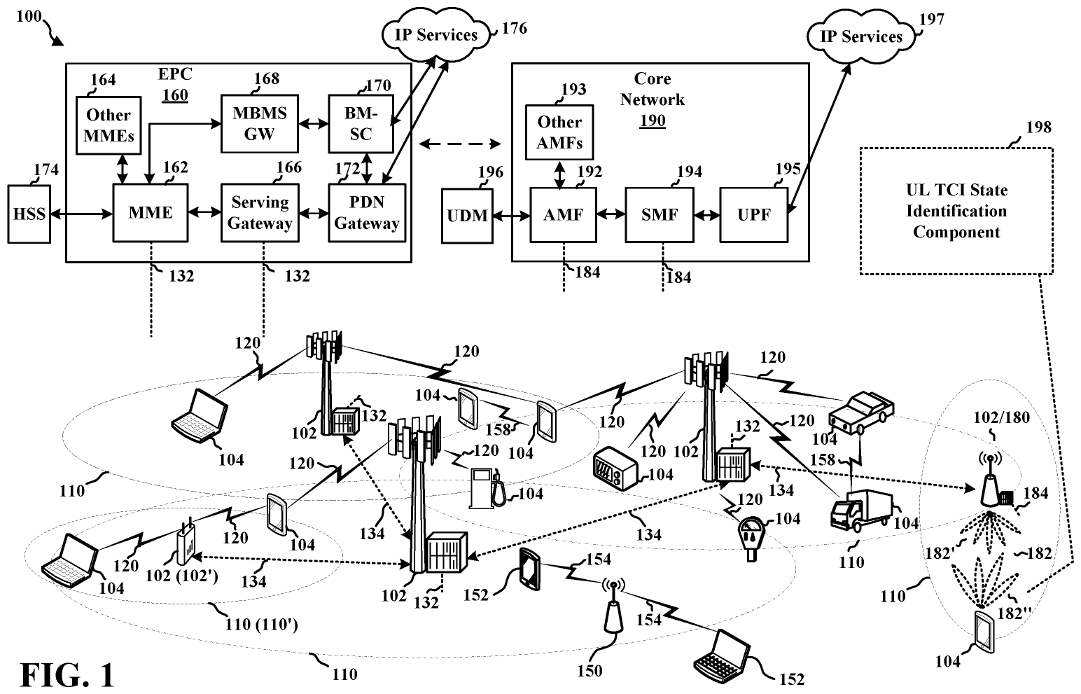

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include an UL TCI state identification component 198 that may be configured to receive an RRC configuration configuring UL TCI states for one or more serving cells; receive DCI indicating an UL TCI state of the configured UL TCI states for at least one UL transmission to at least one serving cell of the one or more serving cells; and transmit the at least one UL transmission based on the indicated UL TCI state. While the following description focuses on 5G NR, the concepts described herein may be applicable to other similar areas, such as LTE, LTE-A, CDMA, GSM, and other wireless technologies.

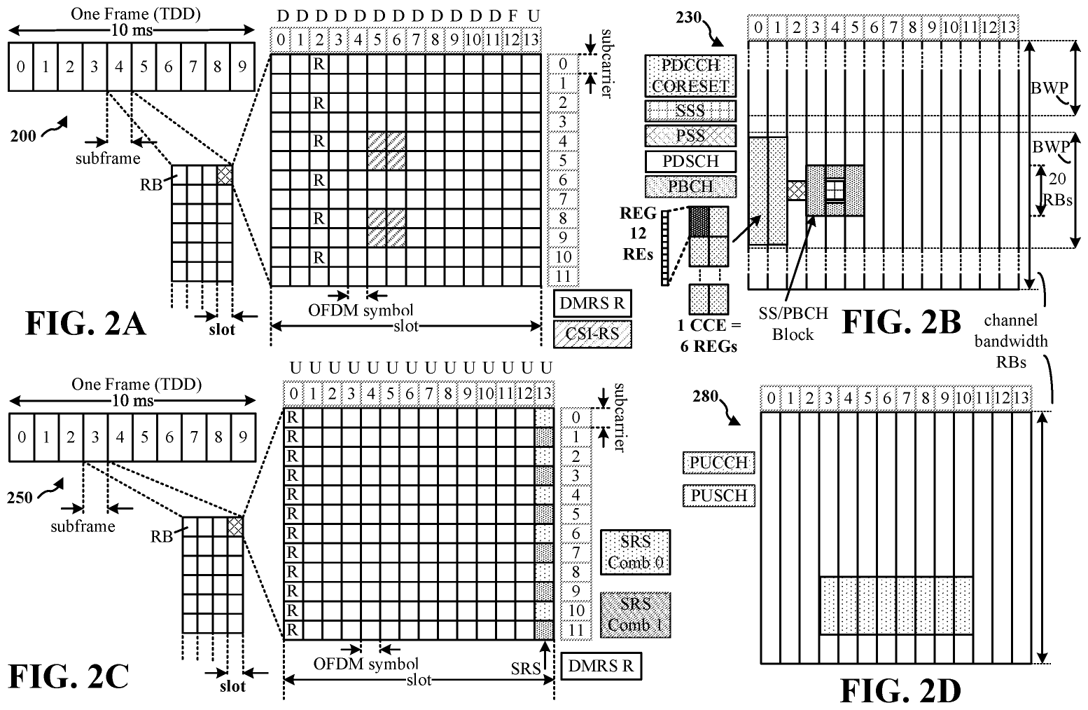

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and CSI-RS for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the PUCCH and DM-RS for the PUSCH. The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit SRS. The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

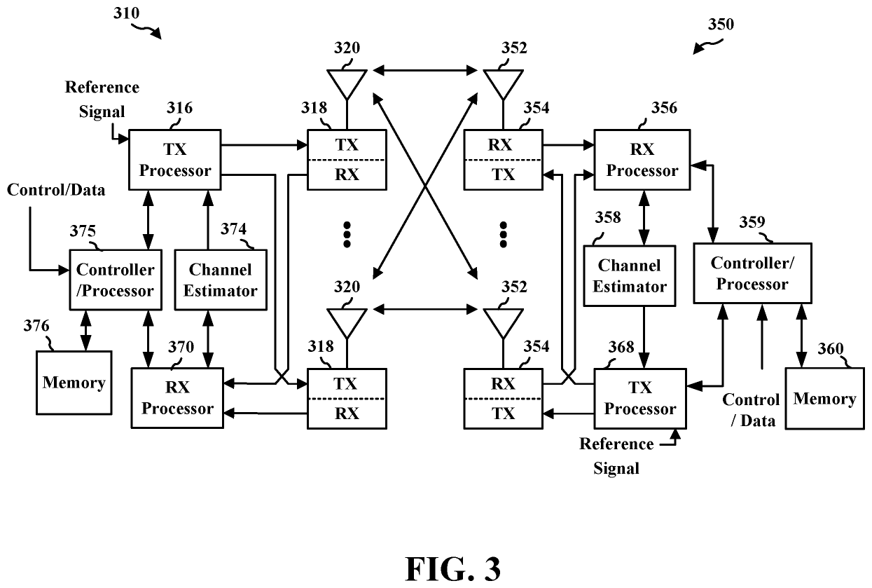

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIGs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

In aspects of wireless communications, e.g., 5G NR, DL and UL can utilize separate TCI states. For example, a first set of reference signals associated with M TCI states may provide QCL information for at least UE-dedicated reception on PDSCH and UE-dedicated reception on all, or a subset, of CORESETs in a CC. QCL information may identify common characteristics between antenna ports. For example, QCL information may indicate similar doppler shift; doppler spread; average delay; and delay spread (type A), similar doppler shift and doppler spread (type B), similar average delay and delay spread (type C), or a similar spatial receiver parameter used to support beamforming (type D). A second set of reference signals associated with N TCI states may provide a reference for determining a common UL transmission filter (or filters) for at least dynamic-grant/configured-grant based PUSCH and all, or a subset, of dedicated PUCCH resources in a CC. In some configurations, the common UL transmission filter(s) may also apply to SRS resources in one or more resource set(s) configured for any of antenna switching, codebook-based, or non-codebook-based UL transmissions.

In some configurations using CA in which multiple CCs are used by the UE to communicate with a set of one or more serving cells, DL TCI states (e.g., a DL TCI state list) for each particular CC (or for each serving cell) may be configured in a PDSCH-Config IE (as an example of a DL config IE) and reused for identifying a TCI state for PDCCH and/or CSI-RS for the particular CC. However, for CA UL transmissions on different CCs and/or with different serving cells there may be different UL transmission configurations for the different CCs or serving cells. For example, a particular CC (or serving cell) may have UL transmissions of only one of PUCCH, PUSCH, or SRS transmissions or any combination of PUCCH, PUSCH, configured-grant PUSCH, and SRS transmissions. Because of the different UL transmission configurations for different CCs and/or different serving cells and the different types of UL transmissions that may be exchanged over different CCs associated with different serving cells there may be a benefit to introduce a set of one or more UL TCI state configuration locations (e.g., in one or more information elements in radio resource control (RRC)), where each of the set of one or more locations can be used to configure UL TCI states (e.g., an UL TCI state list) for at least one type of UL transmission (e.g., PUCCH, PUSCH, configured-grant PUSCH, and SRS transmissions).

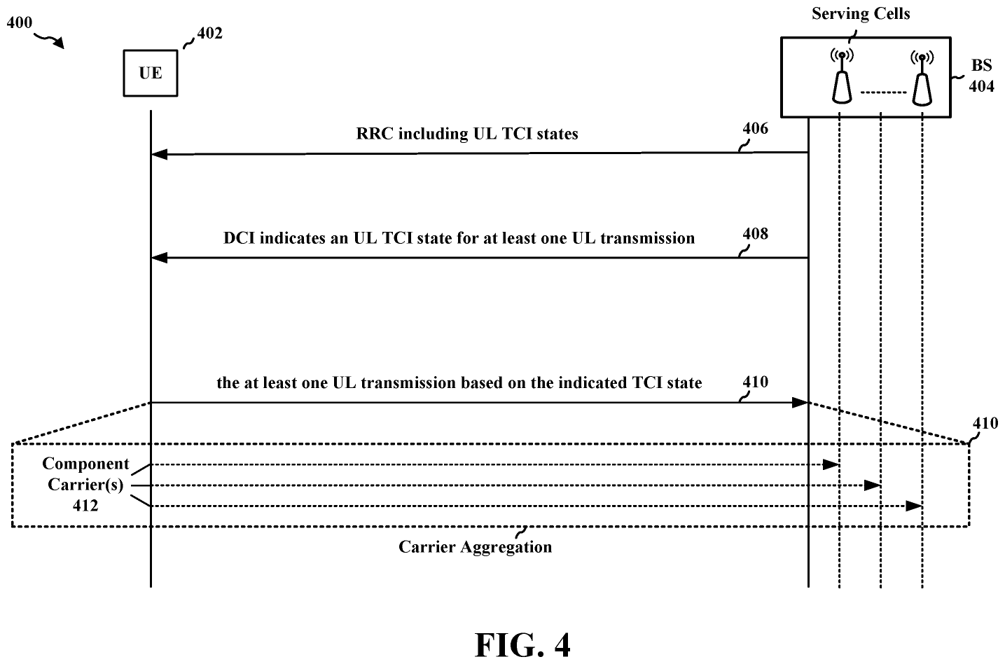

FIG. 4 is a call flow diagram 400 illustrating UL TCI state configuration and indication. As illustrated in FIG. 4, a base station (BS) 404 may be in communication with a UE 402. The BS 404 may include a set of one or more serving cells (e.g., a primary serving cell and a set of secondary serving cells). The set of one or more serving cells in other configurations, e.g., dual connectivity, may belong to multiple base stations. FIG. 4 illustrates that the UE 402 may receive RRC configuration 406 transmitted by BS 404, where RRC configuration 406 includes information for configuring UL TCI states (e.g., configuring a list of TCI states from which a TCI state may be indicated) for one or more of the serving cells of BS 404.

After receiving the RRC configuration 406 to configure the UL TCI states, the UE 402 may receive the DCI 408, that may be transmitted by BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies. The UE 402 may then transmit, at 410, the at least one UL transmission based on the indicated UL TCI state(s) (e.g., the UL TCI state(s) indicated in the DCI 408). In aspects using CA, the at least one UL transmission may be transmitted via a set of CCs 412 to a set of serving cells of the BS 404. The BS 404, through the serving cell(s), may then receive the at least one UL transmission 410.

As illustrated, the UE 402 may be communicating with multiple serving cells (e.g., serving cells within the BS 404 as depicted in FIG. 4 or with multiple BSs) as indicated by the dotted lines indicating a set of component transmissions of the at least one UL transmission 410 that may be transmitted to a corresponding set of serving cells of the BS 404 in some aspects. The UE 402 may use at least one CC 412 to communicate with each of the serving cells. Each CC 412 may be configured with UL TCI states (e.g., a list of TCI states from which a TCI state may be indicated) or the UE may be configured with UL TCI states (e.g., by RRC configuration 406) that may be indicated for any of a set of CCs 412 used to communicate with a set of serving cells. Each CC 412 may carry one or more UL transmissions (e.g., PUCCH, PUSCH, configured-grant PUSCH, or SRS transmissions). A set of UL TCI states may be indicated for each CC 412 (e.g., in DCI associated with the CC 412 such as the DCI 408 received from the BS 404) that may be applied to each type of UL transmission via the CC 412. For example, an indicated UL TCI state(s) may apply to any or all of PUSCH, configured grant PUSCH, PUCCH, and/or SRS transmissions that are transmitted via a particular CC 412.

In some configurations, a UE (e.g., the UE 402) may communicate with additional serving cells in additional base stations (e.g., a base station(s) other than the BS 404). For example, if dual connectivity is enabled, a UE can communicate with (e.g., connect to) additional base stations to improve wireless communication. Each base station may be used to communicate a set of UL or DL channels (e.g., PUSCH, PUCCH, PDSCH, PDCCH or a combination of channels). In some configurations in which the UE connects to multiple base stations, RRC configuration 406 may be an RRC reconfiguration message transmitted to configure UL TCI states for at least one additional serving cell of at least one additional BS. The DCI 408 or an additional DCI transmission may be transmitted to indicate a set of UL TCI states for the UL transmissions associated with the at least one additional serving cell. For example, first and second DCIs received at UE 402 and associated with first and second base stations, respectively, may include different TCI state indicators. The different TCI indicators may identify different TCI states that, in turn, identify different reference signals and a QCL type. For example, both TCI states may identify QCL type D information to support beamforming, but one TCI state may indicate QCL with a particular SSB, while the other TCI state may indicate QCL with CSI-RS or a different SSB. The UE 402 may then use the QCL information regarding the different reference signals to perform beamforming to reach the first and second base stations.

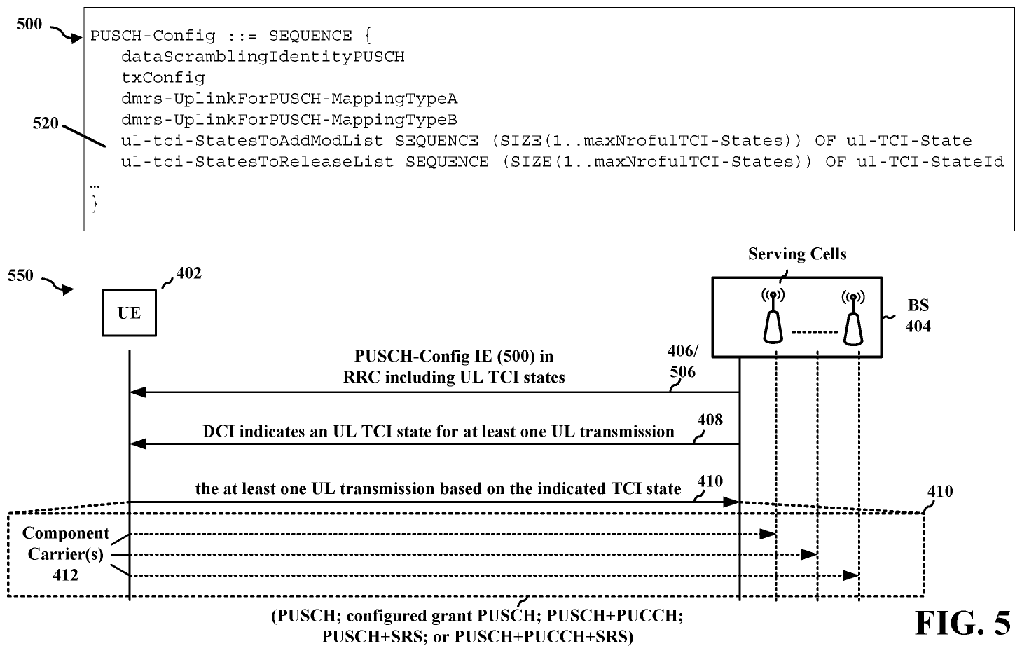

FIGS. 5-11 illustrate a set of operations for configuring UL TCI states using different RRC configuration information elements (IEs). FIG. 5 is a call flow diagram 550 illustrating UL TCI state configuration through a PUSCH-Config IE 500 in the set of RRC configuration IEs. Call flow diagram 550 includes the elements of diagram 400 of FIG. 4. FIG. 5 illustrates that UE 402 may receive RRC configuration 406/506 transmitted by BS 404. RRC configuration 406/506 may include the PUSCH-Config 1E 500 including the UL TCI state configuration (e.g., the TCI state configuration defined by ul-tci-StatesToAdolModList and/or ul-tci-StatesToReleaseList 520). After configuring the UL TCI states based on PUSCH-Config IE 500 included in RRC configuration 406/506, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 5 further illustrates that the UE 402 may transmit the at least one UL transmission 410 that includes one of a PUSCH transmission; a configured grant PUSCH transmission; PUSCH and PUCCH transmissions; PUSCH and SRS transmissions; or PUSCH, PUCCH, and SRS transmissions. The at least one transmission 410 may be transmitted by the UE 402 to a particular serving cell, or set of serving cells, of the BS 404 based on the indicated UL TCI state(s). The UL TCI states configured in the PUSCH-Config IE 500 for the PUSCH transmissions in a bandwidth part of a serving cell may also apply to the other uplink transmissions, if configured, in the same bandwidth part of the same serving cell, such as a configured grant PUSCH transmission, PUCCH transmissions, and/or SRS transmissions.

PUSCH-Config IE 500 may include a set of fields 520 that may include a ul-tci-StatesToAddModList field and a ul-tci-StatesToReleaseList that may identify TCI states used for providing QCL relationships between RS (e.g., CSI-RS, SSB, SRS) in one RS set (e.g., the CSI-RS, SSB, or SRS set associated with the indicated UL TCI state) and PUSCH, PUCCH, and/or SRS DMRS ports. Additional fields may be included in PUSCH-Config IE 500 for configuring other aspects of the PUSCH such as, inter alia, data scrambling (dataScramblingldentityPUSCH), whether the UE uses codebook-based or non-codebook-based transmission (bcConfig), DMRS configuration (dmrs-UplinkForPUSCH-MappingTypeA and/or dmrs-UplinkForPUSCH-MappingTypeB), frequency hopping, resource allocation, and power control. PUSCH-Config IE 500 is provided as a non-limiting example of an uplink channel configuration IE in a currently defined standard that may be renamed or replaced in future releases with an equivalent IE or other data structure.

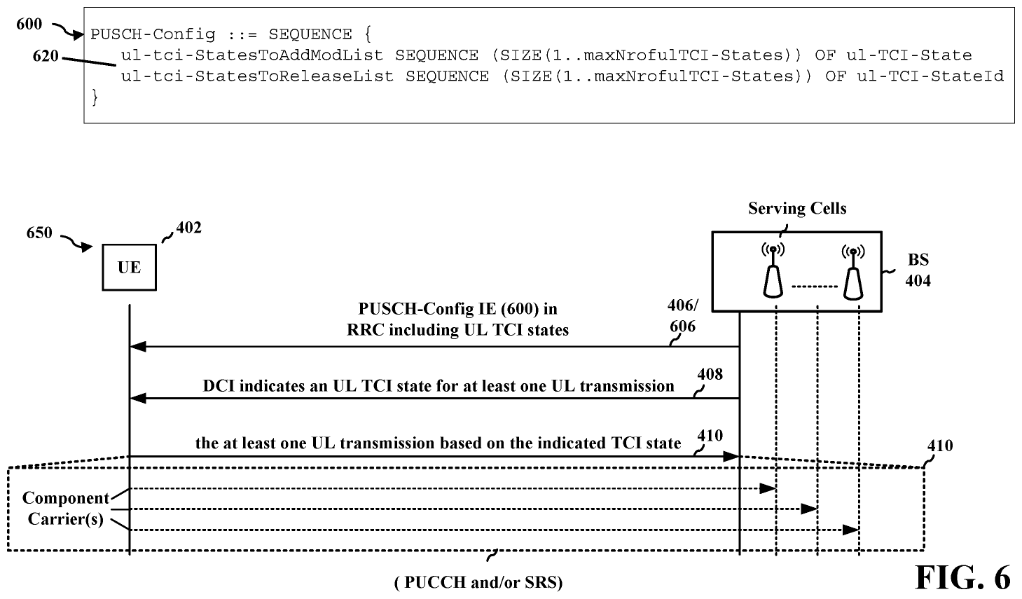

FIG. 6 is a call flow diagram 650 illustrating UL TCI state configuration through a “dummy” PUSCH-Config IE 600 in the set of RRC configuration IEs. Call flow diagram 650 includes the elements of diagram 400 of FIG. 4. FIG. 6 illustrates that UE 402 may receive RRC configuration 406/606 transmitted by BS 404. RRC configuration 406/506 may include the PUSCH-Config IE 600 including the UL TCI state configuration (e.g., the TCI state configuration defined by ul-tci-StatesToAddModList and/or ul-tci-StatesToReleaseList 620). After configuring the UL TCI states based on PUSCH-Config 600 included in RRC configuration 406/606, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 6 further illustrates that the UE 402 may transmit the at least one UL transmission 410 that includes a PUCCH and/or an SRS transmission. The at least one UL transmission 410 may be transmitted by the UE 402 to a particular serving cell, or set of serving cells, of the BS 404 based on the indicated UL TCI state(s). The UL TCI states configured in PUSCH-Config IE 600 in a bandwidth part of a serving cell may apply to other UL transmissions, if configured, in the same bandwidth part of the same serving cell, such as a configured grant PUSCH transmission, PUCCH transmissions, and/or SRS transmissions.

PUSCH-Config IE 600 may be used to configure the UL TCI states for one or more serving cells. The “dummy” PUSCH-Config IE 600 may be used to configure UL TCI states for a particular CC through which PUCCH and/or SRS transmissions are transmitted without a PUSCH transmission. PUSCH-Config IE 600 may include a set of fields 620 that may include a ul-tci-StatesToAddModList field and a ul-tci-StatesToReleaseList that may identify TCI states used for providing QCL relationships between RS (e.g., CSI-RS, SSB, or SRS) in one RS set (e.g., the CSI-RS, SSB, or SRS set associated with the indicated UL TCI state) and PUCCH and/or SRS DMRS ports. Additional fields for configuring other aspects of the PUSCH transmissions may be excluded in “dummy” PUSCH-Config IE 600. PUSCH-Config 1E 600 is provided as a non-limiting example of an uplink channel configuration IE in a currently defined standard that may be renamed or replaced in future releases with an equivalent IE or other data structure.

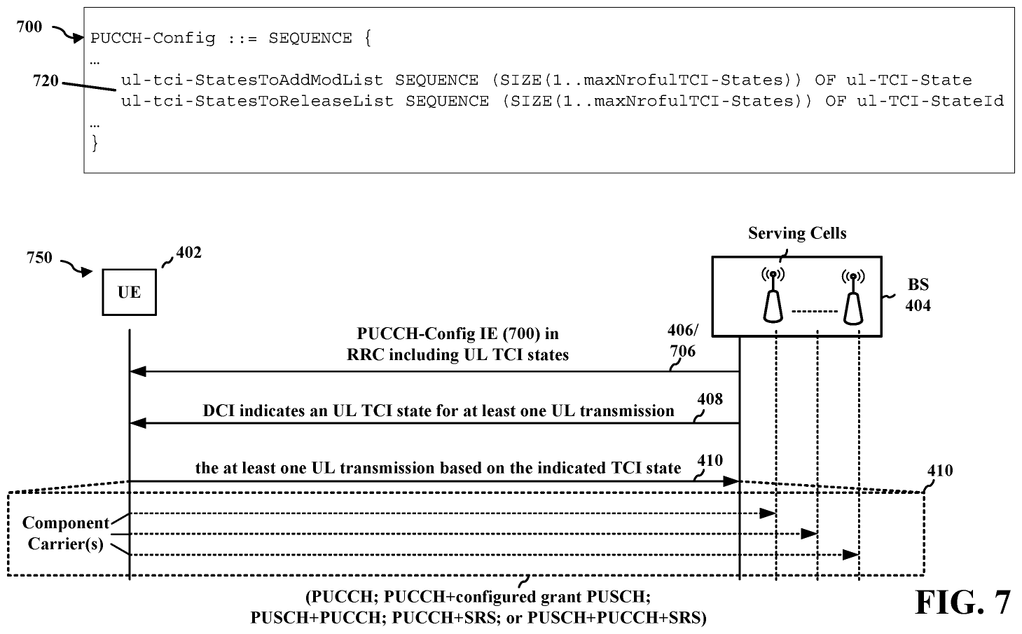

FIG. 7 is a call flow diagram 750 illustrating UL TCI state configuration through a PUCCH-Config IE 700 in the set of RRC configuration IEs. Call flow diagram 750 includes the elements of diagram 400 of FIG. 4. FIG. 7 illustrates that UE 402 may receive RRC configuration 406/706 transmitted by BS 404. RRC configuration 406/706 may include the PUCCH-Config IE 700 including the UL TCI state configuration (e.g., the TCI state configuration defined by ul-tci-StatesToAddModList and/or ul-tci-StatesToReleaseList 720). After configuring the UL TCI states based on PUCCH-Config IE 700 included in RRC configuration 406/706, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 7 further illustrates that the UE 402 may transmit the at least one UL transmission 410 that includes one of a PUCCH transmission; PUCCH and configured grant PUSCH transmissions; PUCCH and PUSCH transmissions; PUCCH and SRS transmissions; or PUSCH, PUCCH, and SRS transmissions. The at least one UL transmission 410 may be transmitted by the UE 402 to a particular serving cell, or set of serving cells, of the BS 404 based on the indicated UL TCI state(s). The UL TCI states configured in PUCCH-Config IE 700 for the PUCCH transmissions in a bandwidth part of a serving cell may also apply to the other uplink transmissions, if configured, in the same bandwidth part of the same serving cell, such as a configured grant PUSCH transmission, PUSCH transmissions, and/or SRS transmissions.

PUCCH-Config IE 700 may be used to configure the UL TCI states for one or more serving cells. The PUCCH-Config IE 700 may be used to configure UL TCI states for a particular CC through which PUCCH transmissions are transmitted with or without other UL channel transmissions. PUCCH-Config IE 700 may include a set of fields 720 that may include a ul-tci-StatesToAddModList field and a ul-tci-StatesToReleaseList that may identify TCI states used for QCL relationships between RS (e.g., CSI-RS, SSB, SRS) in one RS set (e.g., the CSI-RS, SSB, or SRS set associated with the indicated UL TCI state) and the PUSCH, PUCCH, and/or SRS DMRS ports. Additional fields for configuring other aspects of the PUCCH transmissions may be included in PUCCH-Config IE 700. PUCCH-Config IE 700 is provided as a non-limiting example of an uplink channel configuration IE in a currently defined standard that may be renamed or replaced in future releases with an equivalent IE or other data structure.

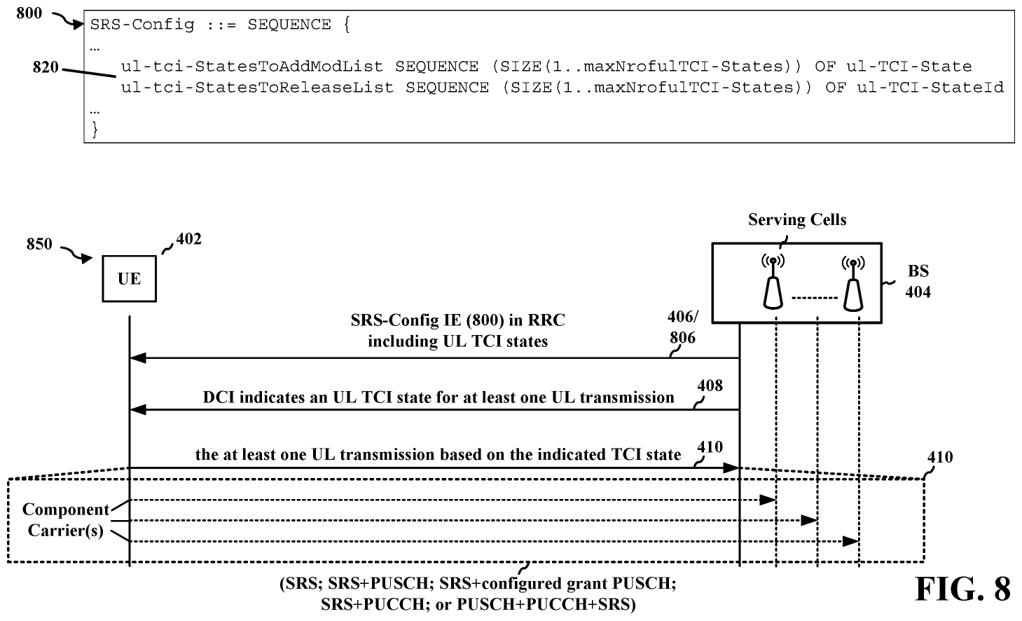

FIG. 8 is a call flow diagram 850 illustrating UL TCI state configuration through an SRS-Config IE 800 in the set of RRC IEs. Call flow diagram 850 includes the elements of diagram 400 of FIG. 4. FIG. 8 illustrates that UE 402 may receive RRC configuration 406/806 transmitted by BS 404. RRC configuration 406/806 may include the SRS-Config IE 800 including the UL TCI state configuration (e.g., the TCI state configuration defined by ul-tci-StatesToAddModList and/or ul-tci-StatesToReleaseList 820). After configuring the UL TCI states based on SRS-Config IE 800 included in RRC configuration 406/806, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 8 further illustrates that the UE 402 may transmit the at least one UL transmission 410 that includes one of an SRS transmission; SRS and PUSCH transmissions; SRS and configured grant PUSCH transmissions; SRS and PUCCH transmissions; or PUSCH, PUCCH, and SRS transmissions. The at least one UL transmission 410 may be transmitted by the UE 402 to a particular serving cell, or set of serving cells, of the BS 404 based on the indicated UL TCI state(s). The UL TCI states configured in SRS-config IE 800 for the SRS transmissions in a bandwidth part of a serving cell may also apply to the other uplink transmissions, if configured, in the same bandwidth part of the same serving cell, such as a configured grant PUSCH transmission, PUCCH transmissions, PUSCH transmissions.

SRS-Config IE 800 may be used to configure the UL TCI states for one or more serving cells. he SRS-Config IE 800 may be used to configure UL TCI states for a particular CC through which SRS transmissions are transmitted with or without other UL channel transmissions. SRS-Config IE 800 may include a set of fields 820 that may include a ul-tci-StatesToAddModList field and a ul-tci-StatesToReleaseList that may identify TCI states used for providing QCL relationships between RS (e.g., CSI-RS, SSB, SRS) in one RS set (e.g., the CSI-RS, SSB, or SRS set associated with the indicated UL TCI state) and the PUSCH, PUCCH, and/or SRS DMRS ports. Additional fields for configuring other aspects of the SRS transmissions may be included in SRS-Config IE 800. SRS-Config IE 800 is provided as a non-limiting example of an uplink channel configuration IE in a currently defined standard that may be renamed or replaced in future releases with an equivalent IE or other data structure.

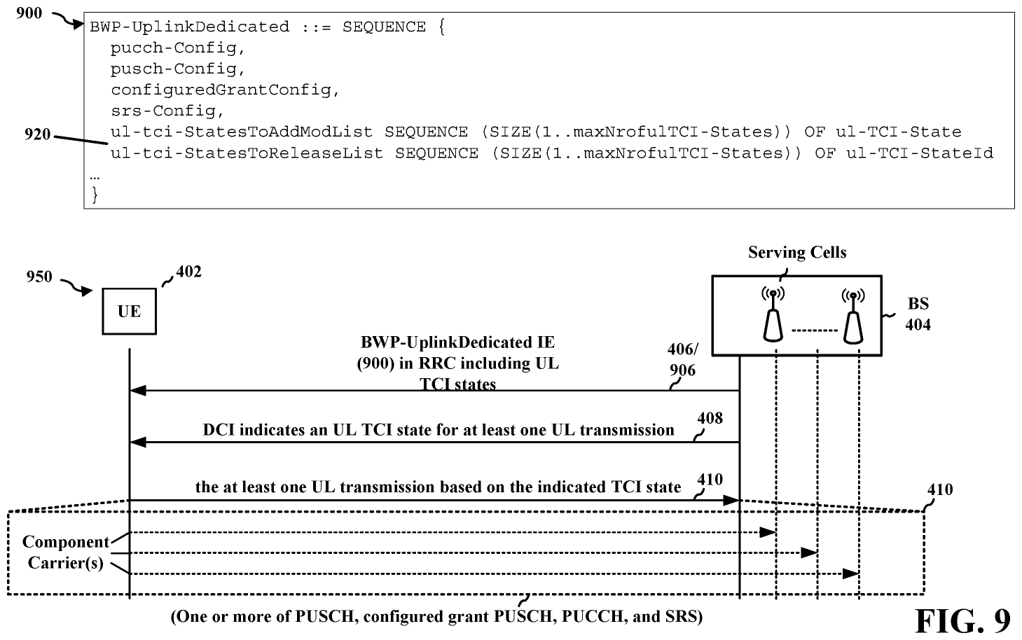

FIG. 9 is a call flow diagram 950 illustrating UL TCI state configuration through a BWP-UplinkDedicatedIE 900 in the set of RRC configuration IEs. Call flow diagram 950 includes the elements of diagram 400 of FIG. 4. FIG. 9 illustrates that UE 402 may receive RRC configuration 406/906 transmitted by BS 404. RRC configuration 406/906 may include the BWP-UplinkDedicated IE 900 including the UL TCI state configuration (e.g., the TCI state configuration defined by ul-tci-StatesToAddModList and/or ul-tci-StatesToReleaseList 920). After configuring the UL TCI states based on BWP-UplinkDedicated IE 900 included in RRC configuration 406/906, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 9 further illustrates that the UE 402 may transmit the at least one UL transmission 410 that includes at least one of a PUSCH transmission, a configured grant PUSCH transmission, a PUCCH transmission, and an SRS transmission. The at least one UL transmission 410 may be transmitted by the UE 402 to a particular serving cell, or set of serving cells, of the BS 404 based on the indicated UL TCI state(s). The UL TCI states configured in a bandwidth part (e.g., in BWP-UplinkDedicated IE 900) of a serving cell may apply to all the uplink transmissions, if configured, in the same bandwidth part of the same serving cell, such as a configured grant PUSCH transmission, PUCCH transmissions, PUSCH transmissions, SRS transmissions.

Diagram 900 illustrates a BWP-UplinkDedicated IE 900 that may be used to configure the UL TCI states for one or more serving cells. BWP-UplinkDedicated IE 900 may include a set of fields 920 that may include a ul-tci-StatesToAddModList field and a ul-tci-StatesToReleaseList that may identify TCI states used for providing QCL relationships between RS (e.g., CSI-RS, SSB, SRS) in one RS set (e.g., the CSI-RS, SSB, or SRS set associated with the indicated UL TCI state) and the PUSCH, PUCCH, and/or SRS DMRS ports. Additional fields for configuring other aspects of the UL transmissions may be included in BWP-UplinkDedicated IE 900. BWP-UplinkDedicated IE 900 is provided as a non-limiting example of an uplink channel configuration IE in a currently defined standard that may be renamed or replaced in future releases with an equivalent IE or other data structure.

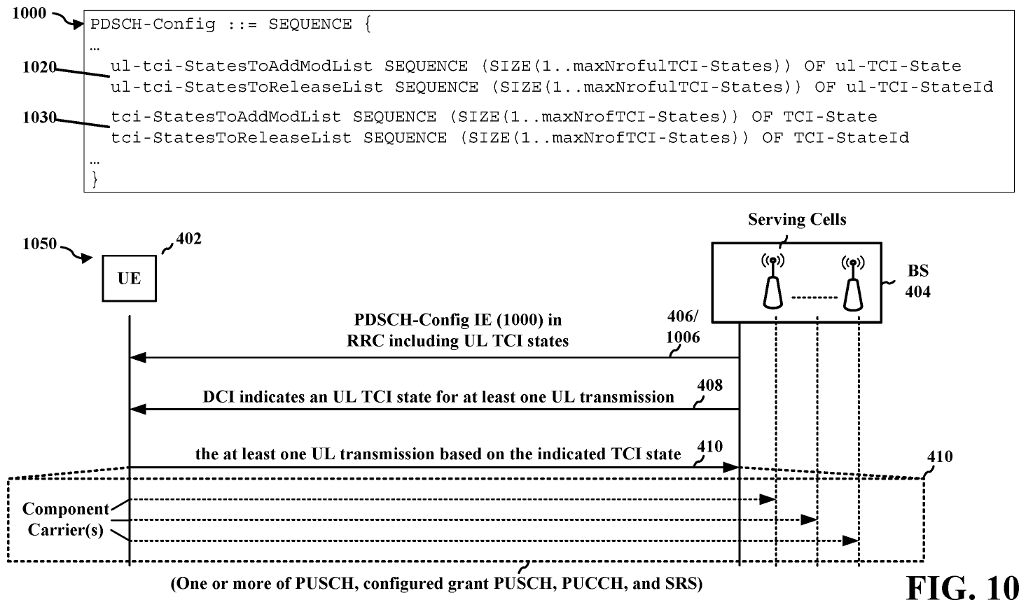

FIG. 10 is a call flow diagram 1050 illustrating UL TCI state configuration through a PDSCH-Config IE 1000 in the set of RRC configuration IEs. Call flow diagram 1050 includes the elements of diagram 400 of FIG. 4. FIG. 10 illustrates that UE 402 may receive RRC configuration 406/1006 transmitted by BS 404. RRC configuration 406/1006 may include the PDSCH-Config IE 1000 including the UL TCI state configuration (e.g., the TCI state configuration defined by ul-tci-StatesToAddModList and/or ul-tci-StatesToReleaseList 1020). After configuring the UL TCI states based on PDSCH-Config IE 1000 included in RRC configuration 406/1006, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 10 further illustrates that the UE 402 may transmit the at least one UL transmission 410 that includes at least one of a PUSCH transmission, a configured grant PUSCH transmission, a PUCCH transmission, and an SRS transmission. The UL TCI states configured in PDSCH-config IE in a downlink bandwidth part of a serving cell may apply to the uplink transmissions if configured in the corresponding uplink bandwidth part of the same serving cell, such as a configured grant PUSCH transmission, PUSCH transmissions, PUCCH transmissions, SRS transmissions. The at least one UL transmission 410 may be transmitted by the UE 402 to a particular serving cell, or set of serving cells, of the BS 404 based on the indicated UL TCI state(s).

PDSCH-Config IE 1000 may be used to configure the UL TCI states for one or more serving cells. PDSCH-Config IE 1000 may include a set of fields 1020 that may include a ul-tci-StatesToAddModList field and a ul-tci-StatesToReleaseList that may identify TCI states used for providing QCL relationships between RS (e.g., CSI-RS, SSB, SRS) in one RS set (e.g., the CSI-RS, SSB, or SRS set associated with the indicated UL TCI state) and the PUSCH, PUCCH, and/or SRS DMRS ports. PDSCH-Config IE 1000 may also include a set of fields 1030 that may include a tci-StatesToAddModList field and a tci-StatesToReleaseList field that identify TCI states used for providing QCL relationships between DL RS (e.g., CSI-RS or SSB) in one RS set (e.g., a CSI-RS or SSB associated with a TCI-state) and the PDCCH DMRS ports. Additional fields for configuring other aspects of the PDSCH transmissions may be included in PDSCH-Config IE 1000. PDSCH-Config IE 1000 is provided as a non-limiting example of a downlink channel configuration IE in a currently defined standard that may be renamed or replaced in future releases with an equivalent IE or other data structure.

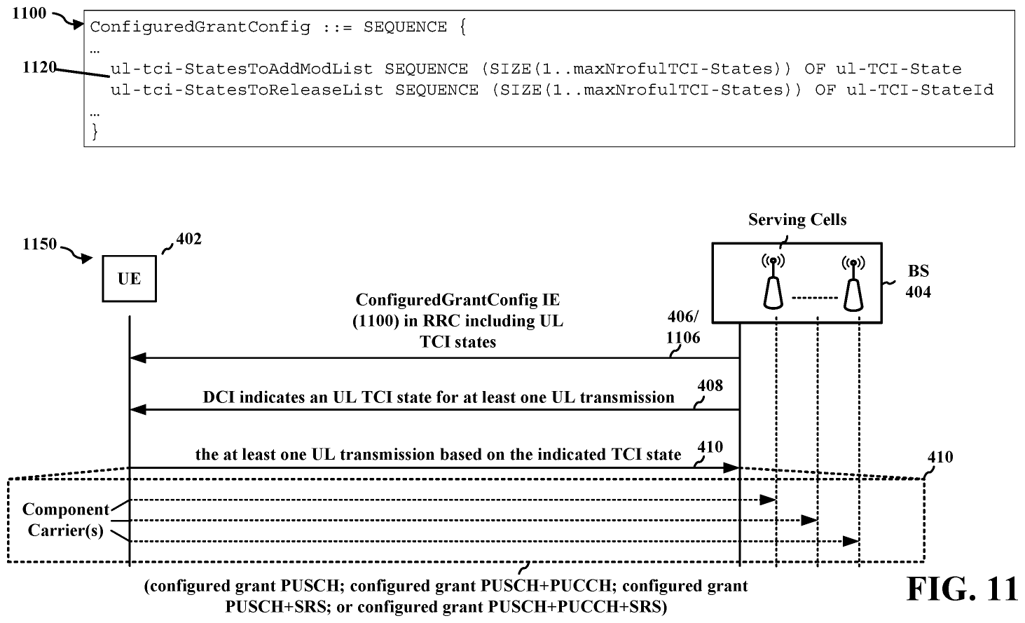

FIG. 11 is a call flow diagram 1150 illustrating UL TCI state configuration through a PUSCH ConfiguredGrantConfig IE 1100 in the set of RRC IEs. Call flow diagram 1150 includes the elements of diagram 400 of FIG. 4. FIG. 11 illustrates that UE 402 may receive RRC configuration 406/1106 transmitted by BS 404. RRC configuration 406/1106 may include the ConfiguredGrantConfig IE 1100 including the UL TCI state configuration (e.g., the TCI state configuration defined by ul-tci-StatesToAddModList and/or ul-tci-StatesToReleaseList 1120). After configuring the UL TCI states based on ConfiguredGrantConfig IE 1100 included in RRC configuration 406/1106, the UE 402 may receive DCI 408 transmitted by the BS 404. DCI 408 may include (1) an UL grant for at least one UL transmission and (2) an indication of an UL TCI state(s) of the configured UL TCI states for the at least one UL transmission. In one aspect, DCI 408 may include an indication of an UL TCI state(s) of the configured UL TCI states for at least one UL transmission, and another DCI may include an UL grant for the at least one UL transmission to which the UL TCI state indicated by DCI 408 applies. In another aspect, DCI 408 may include an indication of an UL TCI state(s) of the configured UL TCI states for at least one UL transmission, and other signaling such as RRC or MAC-CE may indicate an UL grant for the at least one UL transmission to which the UL TCI state indicated by DCI 408 applies.

FIG. 11 further illustrates that the UE 402 may transmit the at least one UL transmission 410 that includes at least one of a configured grant PUSCH transmission; configured grant PUSCH and PUCCH transmissions; configured grant PUSCH and SRS transmissions; and configured grant PUSCH, PUCCH, and SRS transmissions. The at least one UL transmission 410 may be transmitted by the UE 402 to a particular serving cell, or set of serving cells, of the BS 404 based on the indicated UL TCI state(s). The UL TCI states configured in ConfiguredGrantConfig IE 1100 in a bandwidth part of a serving cell may apply to other UL transmissions, if configured, in the same bandwidth part of the same serving cell, such as PUSCH transmissions, PUCCH transmissions, and/or SRS transmissions.

ConfiguredGrantConfig IE 1100 may be used to configure the UL TCI states for one or more serving cells. ConfiguredGrantConfig IE 1100 may include a set of fields 1120 that may include a ul-tci-StatesToAddModList field and a ul-tci-StatesToReleaseList that may identify TCI states used for providing QCL relationships between RS (e.g., CSI-RS, SSB, SRS) in one RS set (e.g., the CSI-RS, SSB, or SRS set associated with the indicated UL TCI state) and the PUSCH, PUCCH, and/or SRS DMRS ports. Additional fields for configuring other aspects of the PUSCH transmissions may be included in ConfiguredGrantConfig IE 1100. ConfiguredGrantConfig IE 1100 is provided as a non-limiting example of an uplink channel configuration IE in a currently defined standard that may be renamed or replaced in future releases with an equivalent IE or other data structure.

As described above in relation to FIGS. 5-11 the RRC configuration configuring the UL TCI states may include the UL TCI information in any of a PUSCH-config IE 500, a dummy PUSCH-config IE 600, a PUCCH-Config IE 700, an SRS-Config IE 800, a BWP-UplinkDedicated IE 900, a PDSCH-Config IE 1000, or a ConfiguredGrantConfig IE 1100. Of course, these specific IEs are provided as examples only and may be generalized as IEs, or subsequent structures defined in later standards, for configuring either uplink or downlink characteristics

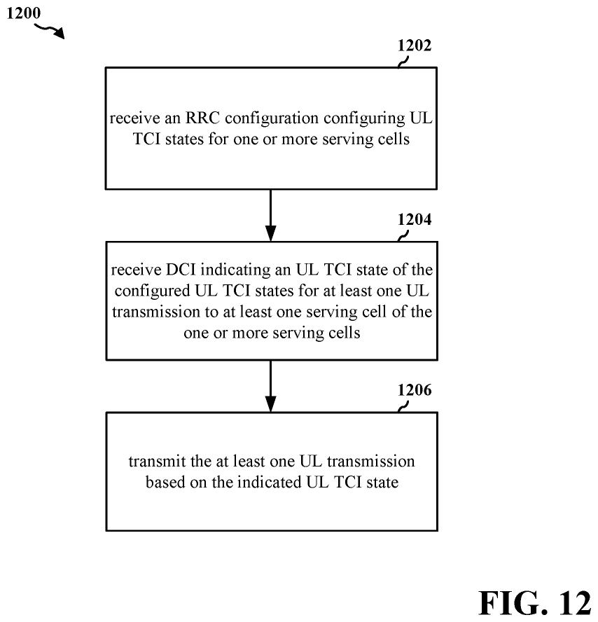

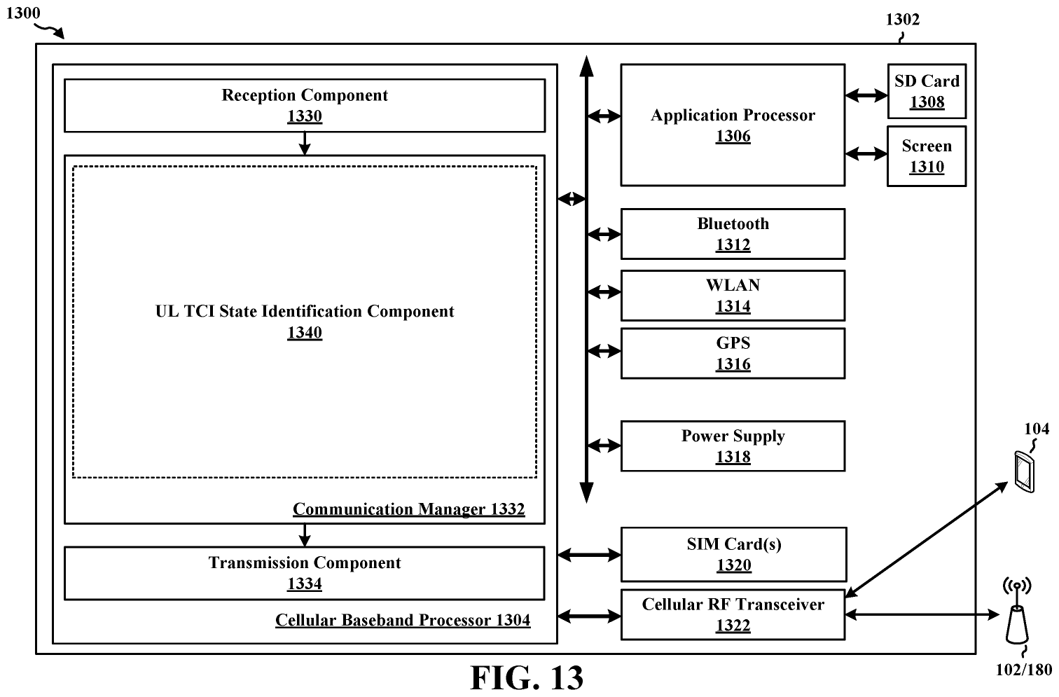

FIG. 12 is a flowchart 1200 of a method of wireless communication. The method may be performed by a UE (e.g., the UE 104; the apparatus 1302). At 1202, the UE may receive an RRC configuration configuring UL TCI states for one or more serving cells. For example, referring to FIGS. 4-11, the UE 402 may receive an RRC configuration 406, 506, 606, 706, 806, 906, 1006, or 1106 configuring UL TCI states for one or more serving cells of the BS 404. For example, 1202 may be performed by the UL TCI state identification component 1340 of FIG. 13.

At 1204, the UE may receive DCI (or other control information) indicating an UL TCI state(s) of the configured UL TCI states for at least one UL transmission to at least one serving cell of the one or more serving cells. For example, referring to FIGS. 4-11, the UE 402 may receive DCI 408 indicating an UL TCI state(s) (from the UL TCI states configured by RRC configuration 406, 506, 606, 706, 806, 906, 1006, or 1106) for at least one UL transmission. For example, 1204 may be performed by the UL TCI state identification component 1340 of FIG. 13.

Finally, at 1206, the UE may transmit the at least one UL transmission based on the indicated UL TCI state(s). For example, referring to FIGS. 4-11, the UE 402 may transmit the at least one UL transmission 410 based on the UL TCI indicated in DCI 408. For example, 1206 may be performed by the UL TCI state identification component 1340 of FIG. 13.

In one configuration, the RRC configuration at 1202 may include a PUSCH configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. the RRC configuration 506 at 1202 may include a PUSCH configuration 500 that configures the UL TCI states for the one or more serving cells of the BS 404. In addition, the at least one UL transmission 410 at 1206 may include at least one of a PUSCH transmission, a configured grant PUSCH transmission, PUCCH transmission, or an SRS transmission based on the indicated UL TCI state.

In one configuration, the at least one UL transmission at 1206 may include one of a PUSCH transmission; a configured grant PUSCH transmission; PUSCH and PUCCH transmissions; PUSCH and SRS transmissions; or PUSCH, PUCCH, and SRS transmissions based on the indicated UL TCI state. For example, referring to FIG. 5, the at least one UL transmission 410 at 1206 may include one of a PUSCH transmission; a configured grant PUSCH transmission; PUSCH and PUCCH transmissions; PUSCH and SRS transmissions; or PUSCH, PUCCH, and SRS transmissions based on the indicated UL TCI state. In one configuration, as illustrated in FIG. 5, the PUSCH configuration 500 in RRC configuration 506 received by UE 402 at 1202 may be a PUSCH-Config IE 500.

In one configuration, the RRC configuration received at 1202 may include PUSCH configuration that configures the UL TCI states for the one or more serving cells and excludes other PUSCH-related configuration information. In addition, the at least one UL transmission at 1206 may include one of an SRS transmission; a PUCCH transmission; or PUCCH and SRS transmissions based on the indicated UL TCI state. For example, referring to FIG. 6, the PUSCH configuration 600 in RRC configuration 606 received by UE 402 at 1202 may be a “dummy” PUSCH-Config IE 600 that excludes other PUSCH-related configuration information. In addition, FIG. 6 illustrates that the transmission 410 at 1206 may include an SRS transmission; a PUCCH transmission; or PUCCH and SRS transmissions based on the indicated UL TCI state.

In one configuration, the RRC configuration at 1202 may include a PUCCH configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. 7, the RRC configuration 706 at 1202 may include a PUCCH configuration 700 that configures the UL TCI states for the one or more serving cells of the BS 404. In addition, the at least one UL transmission 410 at 1206 may include at least one of a PUSCH transmission, a configured grant PUSCH transmission, PUCCH transmission, or an SRS transmission based on the indicated UL TCI state.

In one configuration, the at least one UL transmission at 1206 may include one of a PUCCH transmission; PUCCH and configured grant PUSCH transmissions; PUSCH and PUCCH transmissions; PUCCH and SRS transmissions; or PUSCH, PUCCH, and SRS transmissions based on the indicated UL TCI state. For example, referring to FIG. 7, the at least one UL transmission 410 at 1206 may include one of a PUCCH transmission; PUCCH and configured grant PUSCH transmissions; PUSCH and PUCCH transmissions; PUCCH and SRS transmissions; or PUSCH, PUCCH, and SRS transmissions based on the indicated UL TCI state. In one configuration, as illustrated in FIG. 7, the PUCCH configuration 700 in RRC configuration 706 received by UE 402 at 1202 may be a PUCCH-Config IE 700.

In one configuration, the RRC configuration at 1202 may include an SRS configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. 8, the RRC configuration 806 at 1202 may include an SRS configuration 800 that configures the UL TCI states for the one or more serving cells of the BS 404. In addition, the at least one UL transmission 410 at 1206 may include at least one of a PUSCH transmission, a configured grant PUSCH transmission, PUCCH transmission, or an SRS transmission based on the indicated UL TCI state.

In one configuration, the at least one UL transmission at 1206 may include one of an SRS transmission; SRS and PUSCH transmissions; SRS and configured grant PUSCH transmissions; SRS and PUCCH transmissions; or PUSCH, PUCCH, and SRS transmissions based on the indicated UL TCI state. For example, referring to FIG. 8, the at least one UL transmission 410 at 1206 may include one of an SRS transmission; SRS and PUSCH transmissions; SRS and configured grant PUSCH transmissions; SRS and PUCCH transmissions; or PUSCH, PUCCH, and SRS transmissions based on the indicated UL TCI state. In one configuration, as illustrated in FIG. 8, the SRS configuration 800 in RRC configuration 806 received by UE 402 at 1202 may be an SRS-Config IE 800.

In one configuration, the RRC configuration at 1202 may include a dedicated BWP configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. 9, the RRC configuration 906 at 1202 may include a dedicated BWP configuration 900 that configures the UL TCI states for the one or more serving cells of the BS 404. In one configuration, as illustrated in FIG. 9, the dedicated BWP configuration 900 in RRC configuration 906 received by UE 402 at 1202 may be a dedicated BWP-UplinkDedicated IE 900.

In one configuration, the RRC configuration at 1202 may include a PDSCH configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. the RRC configuration 1006 at 1202 may include a PDSCH configuration 1000 that configures the UL TCI states for the one or more serving cells of the BS 404. In one configuration, as illustrated in FIG. 10, the PDSCH configuration 1000 in RRC configuration 1006 received by UE 402 at 1202 may be a dedicated PDSCH-Config IE 1000.

In one configuration, the RRC configuration at 1202 may include a configured grant PUSCH configuration that configures the UL TCI states for the one or more serving cells. In addition, the at least one transmission at 1206 may include at least one of a PUSCH transmission, a configured grant PUSCH transmission, a PUCCH transmission, or an SRS transmission based on the indicated UL TCI state. For example, referring to FIG. 11, the RRC configuration 1106 at 1202 may include a configured grant PUSCH configuration 1100 that configures the UL TCI states for the one or more serving cells. In addition, the at least one UL transmission 410 at 1206 may include at least one of a PUSCH transmission, a configured grant PUSCH transmission, PUCCH transmission, or an SRS transmission based on the indicated UL TCI state.

In one configuration, the at least one UL transmission at 1206 may include one of a configured grant PUSCH transmission; configured grant PUSCH and PUCCH transmissions; configured grant PUSCH and SRS transmissions; or configured grant PUSCH, PUCCH, and SRS transmissions based on the indicated UL TCI state. For example, referring to FIG. 11, the at least one UL transmission 410 at 1206 may include one of a configured grant PUSCH transmission; configured grant PUSCH and PUCCH transmissions; configured grant PUSCH and SRS transmissions; or configured grant PUSCH, PUCCH, and SRS transmissions based on the indicated UL TCI state. In one configuration, as illustrated in FIG. 11, the PUSCH configuration 1100 in RRC configuration 1106 received by UE 402 at 1202 may be a ConfiguredGrantConfig IE 1100.

FIG. 13 is a diagram 1300 illustrating an example of a hardware implementation for an apparatus 1302. The apparatus 1302 is a UE and includes a cellular baseband processor 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the aforediscussed additional modules of the apparatus 1302.

The communication manager 1332 includes an UL TCI state identification component 1340 that is configured to receive an RRC configuration configuring UL TCI states for one or more serving cells; receive DCI indicating an UL TCI state of the configured UL TCI states for at least one UL transmission to at least one serving cell of the one or more serving cells; and transmit the at least one UL transmission based on the indicated UL TCI state, e.g., as described in connection with 1202, 1204, and 1206 of FIG. 12, respectively. The apparatus may include additional components that perform each of the blocks of the algorithm in the aforementioned flowcharts of FIG. 12. As such, each block in the aforementioned flowcharts of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for receiving an RRC configuration configuring UL TCI states for one or more serving cells. The apparatus 1302, and in particular the cellular baseband processor 1304, may further include means for receiving DCI indicating an UL TCI state of the configured UL TCI states for at least one UL transmission to at least one serving cell of the one or more serving cells. The apparatus 1302, and in particular the cellular baseband processor 1304, may also include means for transmitting the at least one UL transmission based on the indicated UL TCI state. The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

In aspects of wireless communications, e.g., 5G NR, DL and UL can utilize separate TCI states. For example, a first set of reference signals associated with M TCI states may provide QCL information for at least UE-dedicated reception on PDSCH and UE-dedicated reception on all, or a subset, of CORESETs in a CC. QCL information may identify common characteristics between antenna ports. For example, QCL information may indicate similar doppler shift; doppler spread; average delay; and delay spread (type A), similar doppler shift and doppler spread (type B), similar average delay and delay spread (type C), or a similar spatial receiver parameter used to support beamforming (type D). A second set of reference signals associated with N TCI states may provide a reference for determining a common UL transmission filter (or filters) for at least dynamic-grant/configured-grant based PUSCH and all, or a subset, of dedicated PUCCH resources in a CC. In some configurations, the common UL transmission filter(s) may also apply to SRS resources in one or more resource set(s) configured for any of antenna switching, codebook-based, or non-codebook-based UL transmissions.

In some configurations using CA in which multiple CCs are used by the UE to communicate with a set of one or more serving cells, DL TCI states (e.g., a DL TCI state list) for each particular CC (or for each serving cell) may be configured in a PDSCH-Config IE (as an example of a DL config IE) and reused for identifying a TCI state for PDCCH and/or CSI-RS for the particular CC. However, for CA UL transmissions on different CCs and/or with different serving cells there may be different UL transmission configurations for the different CCs or serving cells. For example, a particular CC (or serving cell) may have UL transmissions of only one of PUCCH, PUSCH, or SRS transmissions or any combination of PUCCH, PUSCH, configured-grant PUSCH, and SRS transmissions. Because of the different UL transmission configurations for different CCs and/or different serving cells and the different types of UL transmissions that may be exchanged over different CCs associated with different serving cells there may be a benefit to introduce a set of one or more UL TCI state configuration locations (e.g., in one or more information elements in radio resource control (RRC)), where each of the set of one or more locations can be used to configure UL TCI states (e.g., an UL TCI state list) for at least one type of UL transmission (e.g., PUCCH, PUSCH, configured-grant PUSCH, and SRS transmissions). The multiple locations (e.g., RRC IEs) in which UL TCI state configuration may be configured may be beneficial to allow situation specific signaling (i.e., using a particular RRC IE for configuring UL TCI states on a CC carrying only one of PUSCH, PUCCH, or SRS transmissions).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication of a UE, including receiving an RRC

configuration configuring UL TCI states for one or more serving cells, receiving DCI indicating an UL TCI state of the configured UL TCI states for at least one UL transmission to at least one serving cell of the one or more serving cells, and transmitting the at least one UL transmission based on the indicated UL TCI state.

Aspect 2 is the method of aspect 1, where the RRC configuration includes a PUSCH configuration that configures the UL TCI states for the one or more serving cells, and the transmission includes at least one of a PUSCH transmission, a configured grant PUSCH transmission, a PUCCH transmission, or an SRS transmission based on the indicated UL TCI state.

Aspect 3 is the method of aspect 2, where the transmission includes one of a PUSCH transmission; a configured grant PUSCH transmission; PUSCH and PUCCH transmissions; PUSCH and SRS transmissions; or PUSCH, PUCCH, and SRS transmissions based on the indicated UL TCI state.

Aspect 4 is the method of any of aspects 2 or 3, where the PUSCH configuration that configures the UL TCI states for the one or more serving cells is received in a PUSCH-Config IE.

Aspect 5 is the method of any of aspects 2 or 4, where the RRC configuration including the PUSCH configuration that configures the UL TCI states for the one or more serving cells excludes other PUSCH-related configuration information.

Aspect 6, is the method of aspect 5, wherein the transmission includes one of an SRS transmission; a PUCCH transmission; or PUCCH and SRS transmissions based on the indicated UL TCI state.

Aspect 7 is the method of aspect 1, where the RRC configuration includes a PUCCH configuration that configures the UL TCI states for the one or more serving cells, and the transmission includes at least one of a PUSCH transmission, a configured grant PUSCH transmission, a PUCCH transmission, or an SRS transmission based on the indicated UL TCI state.

Aspect 8 is the method of aspect 7, where the transmission includes one of a PUCCH transmission; PUCCH and configured grant PUSCH transmissions; PUSCH and PUCCH transmissions; PUCCH and SRS transmissions; or PUSCH, PUCCH, and SRS transmissions based on the configured UL TCI state.

Aspect 9 is the method of any of aspects 7 or 8, where the PUCCH configuration that configures the UL TCI states for the one or more serving cells is received in a PUCCH-Config IE.

Aspect 10 is the method of aspect 1, where the RRC configuration includes an SRS configuration that configures the UL TCI states for the one or more serving cells, and the transmission includes at least one of a PUSCH transmission, a configured grant PUSCH transmission, a PUCCH transmission, or an SRS transmission based on the indicated UL TCI state.

Aspect 11 is the method of aspect 10, wherein the transmission includes one of an SRS transmission; SRS and PUSCH transmissions; SRS and configured grant PUSCH transmissions; SRS and PUCCH transmissions; or PUSCH, PUCCH, and SRS transmissions based on the indicated UL TCI state.

Aspect 12 is the method of any of aspects 10 or 11, where the SRS configuration that configures the UL TCI states for the one or more serving cells is received in an SRS-Config IE.

Aspect 13 is the method of aspect 1, where the RRC configuration includes a dedicated BWP configuration that configures the UL TCI states for a BWP for the one or more serving cells, and the transmission includes at least one of a PUSCH transmission, a configured grant PUSCH transmission, a PUCCH transmission, or an SRS transmission on the BWP based on the indicated UL TCI state.

Aspect 14 is the method of aspect 13, where the dedicated BWP configuration that configures the UL TCI states for the one or more serving cells is received in a BWP-UplinkDedicated IE.

Aspect 15 is the method of aspect 1, wherein the RRC configuration includes a PDSCH configuration that configures the UL TCI states for the one or more serving cells, and the transmission includes at least one of a PUSCH transmission, a configured grant PUSCH transmission, a PUCCH transmission, or an SRS transmission based on the indicated UL TCI state.

Aspect 16 is the method of aspect 15, where the PDSCH configuration that configures the UL TCI states for the one or more serving cells is received in a PDSCH-Config IE.

Aspect 17 is an apparatus for wireless communication including at least one processor coupled to a memory and configured to implement a method as in any of aspects 1 to 16.

Aspect 18 is an apparatus for wireless communication including means for implementing a method as in any of aspects 1 to 16.

Aspect 19 is a computer-readable medium storing computer executable code, where the code when executed by a processor causes the processor to implement a method as in any of aspects 1 to 16.

What is claimed is:

1. A method of wireless communication of a user equipment (UE), comprising:
receiving a radio resource control (RRC) configuration configuring uplink (UL) transmission configuration indicator (TCI) states for one or more serving cells;
receiving downlink control information (DCI) indicating an UL TCI state of the configured UL TCI states for at least one UL transmission to at least one serving cell of the one or more serving cells; and
transmitting the at least one UL transmission based on the indicated UL TCI state.

2. The method of claim 1, wherein the RRC configuration includes a physical uplink shared channel (PUSCH) configuration that configures the UL TCI states for the one or more serving cells, and the transmission includes at least one of a PUSCH transmission, a configured grant PUSCH transmission, a physical uplink control channel (PUCCH) transmission, or a sounding reference signals (SRS) transmission based on the indicated UL TCI state.

3. The method of claim 2, wherein the transmission includes one of a PUSCH transmission; a configured grant PUSCH transmission; PUSCH and PUCCH transmissions; PUSCH and SRS transmissions; or PUSCH, PUCCH, and SRS transmissions based on the indicated UL TCI state.

4. The method of claim 2, wherein the PUSCH configuration that configures the UL TCI states for the one or more serving cells is received in a PUSCH-Config information element (IE).

5. The method of claim 2, wherein the RRC configuration including the PUSCH configuration that configures the UL TCI states for the one or more serving cells excludes other PUSCH-related configuration information.

6. The method of claim 5, wherein the transmission includes one of an SRS transmission; a PUCCH transmission; or PUCCH and SRS transmissions based on the indicated UL TCI state.

7. The method of claim 1, wherein the RRC configuration includes a physical uplink control channel (PUCCH) configuration that configures the UL TCI states for the one or more serving cells, and the transmission includes at least one of a physical uplink shared channel (PUSCH) transmission, a configured grant PUSCH transmission, a PUCCH transmission, or a sounding reference signals (SRS) transmission based on the indicated UL TCI state.

8. The method of claim 7, wherein the transmission includes one of a PUCCH transmission; PUCCH and configured grant PUSCH transmissions; PUSCH and PUCCH transmissions; PUCCH and SRS transmissions; or PUSCH, PUCCH, and SRS transmissions based on the configured UL TCI state.

9. The method of claim 7, wherein the PUCCH configuration that configures the UL TCI states for the one or more serving cells is received in a PUCCH-Config information element (IE).

10. The method of claim 1, wherein the RRC configuration includes a sounding reference signals (SRS) configuration that configures the UL TCI states for the one or more serving cells, and the transmission includes at least one of a physical uplink shared channel (PUSCH) transmission, a configured grant PUSCH transmission, a physical uplink control channel (PUCCH) transmission, or an SRS transmission based on the indicated UL TCI state.

11. The method of claim 10, wherein the transmission includes one of an SRS transmission; SRS and PUSCH transmissions; SRS and configured grant PUSCH transmissions; SRS and PUCCH transmissions; or PUSCH, PUCCH, and SRS transmissions based on the indicated UL TCI state.

12. The method of claim 10, wherein the SRS configuration that configures the UL TCI states for the one or more serving cells is received in an SRS-Config information element (LE).

13. The method of claim 1, wherein the RRC configuration includes a dedicated bandwidth part (BWP) configuration that configures the UL TCI states for a BWP for the one or more serving cells, and the transmission includes at least one of a physical uplink shared channel (PUSCH) transmission, a configured grant PUSCH transmission, a physical uplink control channel (PUCCH) transmission, or a sounding reference signals (SRS) transmission on the BWP based on the indicated UL TCI state.

14. The method of claim 13, wherein the dedicated BWP configuration that configures the UL TCI states for the one or more serving cells is received in a BWP-UplinkDedicated information element (IE).

15. The method of claim 1, wherein the RRC configuration includes a physical downlink shared channel (PDSCH) configuration that configures the UL TCI states for the one or more serving cells, and the transmission includes at least one of a physical uplink shared channel (PUSCH) transmission, a configured grant PUSCH transmission, a physical uplink control channel (PUCCH) transmission, or a sounding reference signals (SRS) transmission based on the indicated UL TCI state.

16. The method of claim 15, wherein the PDSCH configuration that configures the UL TCI states for the one or more serving cells is received in a PDSCH-Config information element (IE).

17. An apparatus for wireless communication, the apparatus being a first user equipment (UE) comprising:
a memory; and
at least one processor coupled to the memory and configured to:
receive a radio resource control (RRC) configuration configuring uplink (UL) transmission configuration indicator (TCI) states for one or more serving cells;
receive downlink control information (DCI) indicating an UL TCI state of the configured UL TCI states for at least one UL transmission to at least one serving cell of the one or more serving cells; and
transmit the at least one UL transmission based on the indicated UL TCI state.

18. The apparatus of claim 17, wherein the RRC configuration includes a physical uplink shared channel (PUSCH) configuration (PUSCH-Config) information element (IE) that configures the UL TCI states for the one or more serving cells, and the transmission includes at least one of a PUSCH transmission, a configured grant PUSCH transmission, a physical uplink control channel (PUCCH) transmission, or a sounding reference signals (SRS) transmission based on the indicated UL TCI state.

19. The apparatus of claim 18, wherein the transmission includes one of a PUSCH transmission; a configured grant PUSCH transmission; PUSCH and PUCCH transmissions; PUSCH and SRS transmissions; or PUSCH, PUCCH, and SRS transmissions based on the indicated UL TCI state.

20. The apparatus of claim 18, wherein the PUSCH-Config IE that configures the UL TCI states for the one or more serving cells excludes other PUSCH-related configuration information.

21. The apparatus of claim 20, wherein the transmission includes one of an SRS transmission; a PUCCH transmission; or PUCCH and SRS transmissions based on the indicated UL TCI state.

22. The apparatus of claim 17, wherein the RRC configuration includes a physical uplink control channel (PUCCH) configuration (PUCCH-Config) information element (IE) that configures the UL TCI states for the one or more serving cells, and the transmission includes at least one of a physical uplink shared channel (PUSCH) transmission, a configured grant PUSCH transmission, a PUCCH transmission, or a sounding reference signals (SRS) transmission based on the indicated UL TCI state.

23. The apparatus of claim 22, wherein the transmission includes one of a PUCCH transmission; PUCCH and configured grant PUSCH transmissions; PUSCH and PUCCH transmissions; PUCCH and SRS transmissions; or PUSCH, PUCCH, and SRS transmissions based on the configured UL TCI state.

24. The apparatus of claim 17, wherein the RRC configuration includes a sounding reference signals (SRS) configuration (SRS-Config) information element (IE) that configures the UL TCI states for the one or more serving cells, and the transmission includes at least one of a physical uplink shared channel (PUSCH) transmission, a configured grant PUSCH transmission, a physical uplink control channel (PUCCH) transmission, or an SRS transmission based on the indicated UL TCI state.

25. The apparatus of claim 24, wherein the transmission includes one of an SRS transmission; SRS and PUSCH transmissions; SRS and configured grant PUSCH transmissions; SRS and PUCCH transmissions; or PUSCH, PUCCH, and SRS transmissions based on the indicated UL TCI state.

26. The apparatus of claim 17, wherein the RRC configuration includes a dedicated bandwidth part (BWP) configuration (BWP-UplinkDedicated) information element (IE) that configures the UL TCI states for a BWP for the one or more serving cells, and the transmission includes at least one of a physical uplink shared channel (PUSCH) transmission, a configured grant PUSCH transmission, a physical uplink control channel (PUCCH) transmission, or a sounding reference signals (SRS) transmission on the BWP based on the indicated UL TCI state.

27. The apparatus of claim 17, wherein the RRC configuration includes a physical downlink shared channel (PDSCH) configuration (PDSCH-Config) information element (IE) that configures the UL TCI states for the one or more serving cells, and the transmission includes at least one of a physical uplink shared channel (PUSCH) transmission, a configured grant PUSCH transmission, a physical uplink control channel (PUCCH) transmission, or a sounding reference signals (SRS) transmission based on the indicated UL TCI state.

28. An apparatus for wireless communication, comprising:
means for receiving a radio resource control (RRC) configuration configuring uplink (UL) transmission configuration indicator (TCI) states for one or more serving cells;
means for receiving downlink control information (DCI) indicating an UL TCI state of the configured UL TCI states for at least one UL transmission to at least one serving cell of the one or more serving cells; and
means for transmitting the at least one UL transmission based on the indicated UL TCI state.

29. The apparatus of claim 28, wherein the RRC configuration includes a physical uplink shared channel (PUSCH) configuration that configures the UL TCI states for the one or more serving cells, and the transmission includes at least one of a PUSCH transmission, a configured grant PUSCH transmission, a physical uplink control channel (PUCCH) transmission, or a sounding reference signals (SRS) transmission based on the indicated UL TCI state.

30. A computer-readable medium storing computer executable code, the code, when executed by a processor of a device at a user equipment (UE), causes the processor to:
receive a radio resource control (RRC) configuration configuring uplink (UL) transmission configuration indicator (TCI) states for one or more serving cells;
receive downlink control information (DCI) indicating an UL TCI state of the configured UL TCI states for at least one UL transmission to at least one serving cell of the one or more serving cells; and
transmit the at least one UL transmission based on the indicated UL TCI state.
